(19) United States
(12) Patent Application Publication
(10) Pub. No.: US 2015/0142780 A1
(43) Pub. Date: May 21, 2015

(54) APPARATUS AND METHOD FOR ANALYZING EVENT TIME-SPACE CORRELATION IN SOCIAL WEB MEDIA

(71) Applicant: ELECTRONICS AND TELECOMMUNICATIONS RESEARCH INSTITUTE, Daejeon (KR)

(72) Inventors: Hyo Jung OH, Daejeon (KR); Yong Jin BAE, Daejeon (KR); Hyun Ki KIM, Daejeon (KR); Chung Hee LEE, Daejeon (KR); Yo Han JO, Daejeon (KR); Soo Jong LIM, Daejeon (KR); Jeong HEO, Daejeon (KR); Yeo Chan YOON, Daejeon (KR); Yoon Jae CHOI, Daejeon (KR); Myung Gil JANG, Daejeon (KR); Pum Mo RYU, Daejeon (KR); Mi Ran CHOI, Daejeon (KR)

(73) Assignee: ELECTRONICS AND TELECOMMUNICATIONS RESEARCH INSTITUTE, Daejeon (KR)

(21) Appl. No.: 14/255,410

(22) Filed: Apr. 17, 2014

(30) Foreign Application Priority Data
Nov. 21, 2013 (KR) 10-2013-0142223

(51) Int. Cl. G06F 17/30

(52) U.S. Cl. CPC G06F 17/30696
USPC 707/722

(57) ABSTRACT

Provided are an apparatus for analyzing an event time-space correlation in a social web media and an operating method thereof. The apparatus includes a collection unit configured to collect a text type of document data from the social web media, a storage unit configured to store an event keyword indicating an event and event-related information including event time-space information corresponding to the event keyword, an extraction unit configured to linguistically analyze the document data to extract the event keyword and the event-related information associated with the event keyword from the document data based on a result of the linguistic analysis, and an output unit configured to receive the event keyword and event-related information and convert the received event keyword and event-related information into visual information and output the visual information.

### CROSS-REFERENCE TO RELATED APPLICATIONS

This application claims priority under 35 U.S.C. §119 to Korean Patent Application No. 10-2013-0142223, filed on Nov. 21, 2013, the disclosure of which is incorporated herein by reference in its entirety.

### TECHNICAL FIELD

The present invention relates to a technology for analyzing information for content in a social web media, and more particularly, to a technology for analyzing a correlation between event information and time-space information associated with the event information in the social web media.

### BACKGROUND

As the amount of digital content on the Internet and mobile increase geometrically due to development of communication networks, the “big data” age has come. In addition, news delivery media are being evolved from printed matter to web and mobile. In particular, a site that provides an online news service shows several pieces of news to users according to their rankings obtained by measuring importance and real-time in view of users. Recently, research is being conducted to automatically extract information from web news or unformatted text to summarize its topic or extract a core incident or event.

The term “event” generally indicates an issue attracting the great concern. However, the term “event” in terms of information extraction for digital information processing indicates an information extraction target as information about the core incident or topic written in a given document. The event may be classified into a one-off event and a continuous event according to its characteristic.

The one-off event such as a car accident or robbery indicates an event having a weak correlation with its similar event occurring in another area or time zone although a specific event has occurred. The continuous event such as a communicable disease or typhoon indicates an event spreading to an adjacent area with time after an initial event occurs. Since the continuous event has a greater social effect than the off-one event, if a continuous event occurring on online content may be automatically detected and tracked, it is possible to analyze an event occurrence path and a spread range after an event initially occurs, thereby assisting in establishing a quick and effective solution.

There are many technologies related to Location Based Services (LBSs) (for example, foursquare, I′mIN, etc.) for analyzing and visualizing regional information in a current social web media, however, most of the technologies are used to extract the regional information using GPS information and metadata, such as RFID tag, which is formatted and attached to the media and thus cannot analyze time-space information expressed with various words in a sentences of the social web media to automatically coordinate corresponding information.

In addition, a service for searching for a tweet including a specific word in the social media is provided. However, the service cannot automatically extract issues (events or incidents) associated to a user, groups the issues into the same event, and analyze a correlation according to variation in time and space between the issues, or cannot analyze and visualize how specific user groups or issue events are moved and spread according to variation in time and space.

Furthermore, a method of analyzing a user network according to a topic on a social media is provided, but this method is limited to how a user group is created and varied with respect to a specific topic, such that variation in a user, an event, and time and space cannot be analyzed.

### SUMMARY

Accordingly, the present invention provides a technical solution for extracting an event and time-space information associated with the event from document data of a social web media and analyzing and visualizing a correlation therebetween.

In one general aspect, an apparatus for analyzing an event time-space correlation in a social web media, the apparatus comprising: a collection unit configured to collect a text type of document data from the social web media; an extraction unit configured to analyze a language contained in the document data to extract an event keyword indicating an event and event-related information associated with the event keyword based on a result of the analysis; a storage unit configured to store the extracted event keyword and event-related information; and an output unit configured to receive the event keyword and event-related information stored in the storage unit to visualize and output the received event keyword and event-related information, in which the event-related information comprises at least one of user personal information and event time-space information including event time information and event location information about the event.

The extraction unit may perform at least one of morphology analysis and named entity recognition to linguistically analyze the document data, select an event sentence including the event keyword from among the analyzed document data and extract the event-related information using vocabulary data included in the event sentence, extract the event time information in additional consideration of at least one of a document creation time and a document modification time when the document data is attached to the social web media, and extract the event location information using at least one of creation location coordinate data where the document data is attached to the social web media and vocabulary data indicating a location in the document data.

The extraction unit may normalize the extracted event time-space information, normalize the event location information using at least one of previously stored GPS coordinate information and region code information, extract a plurality of event keywords indicating the same event as the event keyword from document data collected from a plurality of social web media to set the plurality of event keywords as one event group, extract event-related information corresponding to the plurality of event keywords contained in the event group from the document data, and sort relations between the plurality of event keywords contained in the event group with respect to one piece of information among the related-art information to check a correlation therebetween.

The output unit may map the event-related information onto a map image to output a result of the mapping, and the apparatus further includes an input unit configured to receive a retrieval range of the event keyword and the event-related information, in which the output unit acquires the event-related information included in the retrieval range from the storage unit corresponding to the received event keyword to output the acquired event-related information.

When at least one piece of information is primarily selected from among the outputted event-related information, the output unit may acquire the event keyword corresponding to the primarily selected event-related information and the event-related information from the storage unit to primarily output the event related information, and when at least one piece of information is secondarily selected from among the primarily outputted event-related information, the output unit secondarily outputs the document data from which the secondarily selected event-related information has been extracted.

In another general aspect, a method of operating an apparatus for analyzing an event time-space correlation in a social web media, the method including: collecting a text type of document data from the social web media; analyzing a language contained in the collected document data; extracting an event keyword indicating an event and event-related information associated with the event keyword based on a result of the linguistic analysis; and mapping the event keyword and the event-related information onto a map image to display a result of the mapping on a screen.

The extracting may include extracting as the event-related information event time-space information including event time information and event location information about the event and user personal information associated with the event, and the analyzing may include performing at least one of morphology analysis and named entity recognition to linguistically analyze the document data.

The extracting may include: selecting an event sentence including the event keyword from among the document data based on a result of the linguistic analysis; and extracting the event-related information using vocabulary data contained in the selected event sentence, and the extracting may include extracting the event time information in consideration of at least one of a document creation time and a document modification time when the document data is attached to the social web media.

The extracting may include normalizing and extracting the event location information using at least one of previously stored GPS coordinate information and region code information.

The extracting may include: extracting a plurality of event keywords indicating the same event as the event keyword from document data collected from a plurality of social web media to set the extracted plurality of event keywords as one event group; and extracting event-related information corresponding to the plurality of event keywords contained in the event group from the document data.

The outputting may include mapping the event-related information onto a map image to output a result of the mapping, and include when at least one piece of information is primarily selected from among the outputted event-related information, primarily outputting the event keyword corresponding to the primarily selected event-related information and the event-related information; and when at least one piece of information is secondarily selected from among the primarily outputted event-related information, secondarily outputting the document data from which the secondarily selected event-related information has been extracted.

Other features and aspects will be apparent from the following detailed description, the drawings, and the claims.

### BRIEF DESCRIPTION OF THE DRAWINGS

FIG. 1 is a block diagram showing an apparatus for analyzing an event correlation over time and space in a social web media according to an embodiment of the present invention.

FIG. 2 is a view illustrating a linguistic analysis of document data according to the present invention.

FIG. 3 is a view illustrating an event sentence in a document data according to the present invention.

FIG. 4 is a view illustrating normalization of event-related information according to the present invention.

FIG. 5 is a view illustrating sorting based on an event occurrence time according to the present invention.

FIG. 6 is a first exemplary view illustrating an output of event-related information according to the present invention.

FIGS. 7A and 7B are each a second exemplary view illustrating an output of event-related information according to the present invention.

FIG. 8 is a third exemplary view illustrating an output of event-related information according to the present invention.

FIG. 9 is a fourth exemplary view illustrating an output of event-related information according to the present invention.

FIG. 10 is a flowchart illustrating a method of operating an apparatus for analyzing an event correlation over time and space in a social web media according to an embodiment of the present invention.

FIG. 11 is block diagram illustrating a computer system for analyzing event time-space correlation in social web media.

### DETAILED DESCRIPTION OF EMBODIMENTS

The above and other aspects of the present invention will be more apparent through exemplary embodiments described with reference to the accompanying drawings. Hereinafter, the present invention will be described in detail through the embodiments of the present invention so that those skilled in the art can easily understand and implement the present invention.

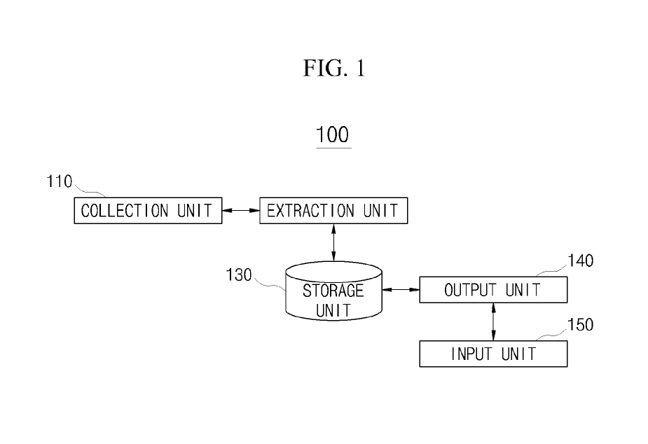

FIG. 1 is a block diagram showing an apparatus for analyzing an event correlation over time and space in a social web media according to an embodiment of the present invention. As shown in FIG. 1, the apparatus for analyzing an event correlation over time and space includes a collection unit 110, an extraction unit 120, a storage unit 130, an output unit 140, and an input unit 150.

The collection unit 110 is configured to collect data from a social web media. Preferably, the collection unit 110 collects a text type of document data from the social web media. In this case, the collection unit 110 may collect the document data from a variety of information sources (for example, a social web media such as a Social Networking Service (SNS) having a news, a blog, Twitter, and Facebook). In addition, the collection unit 110 may collect the document data from a database of a public institution if the document data is accessible to the public.

The extraction unit 120 is configured to extract an event keyword and event-related information about the event keyword from the document data collected by the collection unit 110 and may be a Central Processing Unit (CPU).

First, the extraction unit 120 analyzes a language contained in the document data collected by the collection unit 110. Here, the extraction unit 120 performs at least one of morphology analysis and Named Entity Recognition (NER) to linguistically analyze the document data.

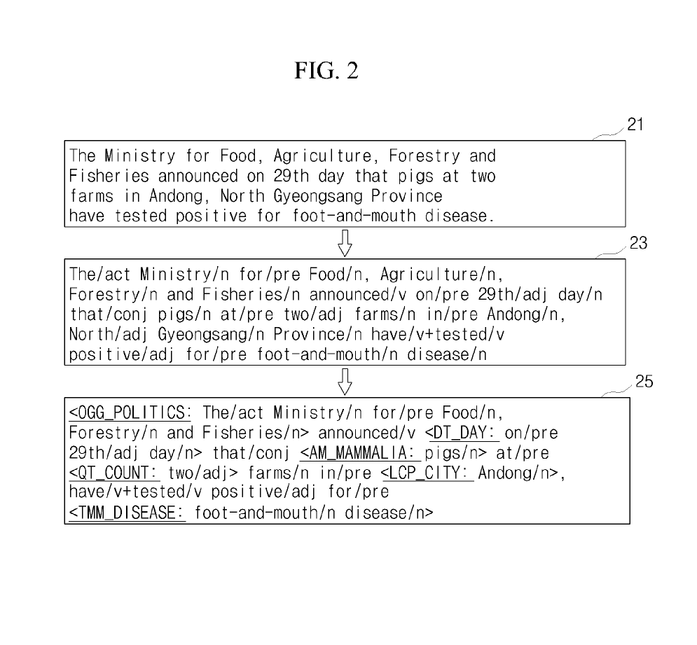

For example, when the document data collected by the collection unit 110 is the same as a portion 21 of FIG. 2, the extraction unit 120 performs morphology analysis to obtain a result as shown in a portion 23 of FIG. 2. Here, ‘n,’ ‘v,’ ‘pre,’ etc. are Part Of Speech (POS) tags including noun, verb, preposition, etc. Information on the POS tags may be previously stored in the storage unit 130. In addition, the extraction unit 120 performs named entity recognition (e.g., recognizing a proper noun such as a person name, an organization name, and a place name) to obtain a result as shown in a portion 25 of FIG. 2. Here, <OGG_POLITICS>, <DY_DAY>, <LCP_PROVINCE>, <QT_COUNT>, etc. are entity name tags corresponding to public institution, date, province, and quantity. Information on the entity name tags may be previously stored in the storage unit 130.

The extraction unit 120 extracts an event keyword and also event-related information associated with the event keyword from the linguistically analyzed document data.

To this end, first, the extraction unit 120 selects an event sentence having a high possibility of including the event keyword from among the linguistically analyzed document data. The event sentence is a core element of the event information, which includes details of the event and has a high possibility of including information about an event occurrence time and an event occurrence place. Thus event time-space Information including event time information and event location information may be extracted from the event sentence.

In this case, the event keyword may be a noun in the event sentence, such that the extraction unit 210 may extract the event keyword from the event sentence using a result of the morphology analysis and named entity recognition. For example, the event keyword may be a disease (for example, a foot-and-mouth disease and a swine flu, etc.), an incident/accident (for example, an air crash), a natural disaster (for example, an earthquake and a forest fire), etc. Furthermore, the event keyword may be a case in which any incident or accident occurs in a subject or object of the event in the document data and the event sentence.

When the event keyword is extracted, the extraction unit 120 extracts the event time information from the event sentence. For example, the extraction unit 120 may extract the event time information by recognizing a noun meaning a date from the linguistically analyzed document data. Specifically, the extraction unit 120 may recognize words (for example, tomorrow, the day after tomorrow, and yesterday) tagged with time entity names such as <DT_DAY>, <DT_OTHERS>, and <TI_DURATION>, that is, words representing a date or period such as year, month, date, and time from the linguistically analyzed event sentence to extract the event time information. To this end, word information (tagging information) representing date and time may be previously stored in the storage unit 130.

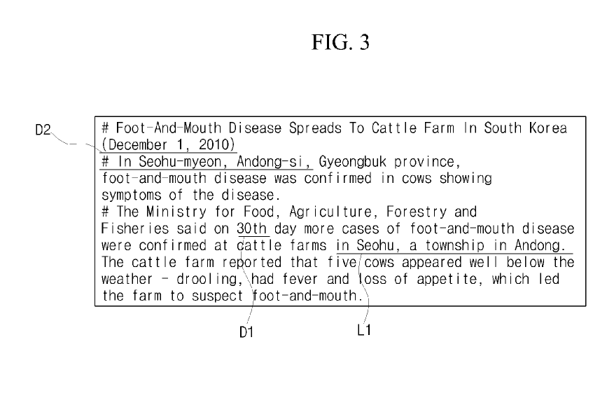

Additionally, the extraction unit 120 may extract the event time information in consideration of a creation or modification time when the document data is attached (posted) to a social web media in order to infer the event time information (for example, year, month, day, and time) from insufficient information. For example, as shown in FIG. 3, the word meaning a date is 30th day D1, but year and month are not specified. In this case, the extraction unit 120 may infer that the 30th day in the event sentence indicates Nov. 30, 2010 D3 in consideration of a date when the document data included in the event sentence has been posted on the social web media, that is, a new reporting date being Dec. 1, 2010 D2, to extract the event time information.

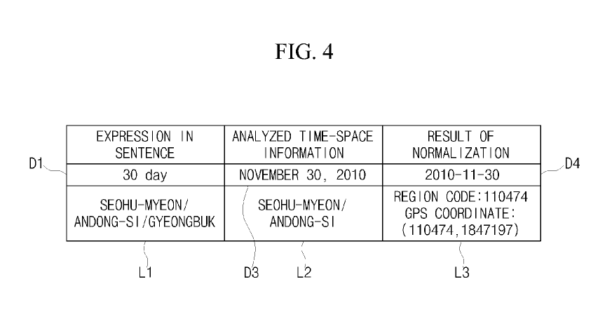

When the event time information is extracted from the event sentence, the extraction unit 120 normalizes the extracted event time information. For example, as shown in FIG. 4, the extraction unit 120 may normalize the extracted event time information, Nov. 30, 2010 D3, into a form where Nov. 30, 2010 D4. Here, the normalization form may be predetermined, and one of various forms such as YYYY-MM-DD, YY-MM-DD, and MM-DD-YY may be predetermined. As such, by normalizing the event time information, the event information may be effectively sorted in order of time.

In addition, when the event keyword is extracted, the extraction unit 120 extracts event location information from the event sentence. Specifically, the extraction unit 120 may extract the event location information by recognizing a proper noun meaning a region from the linguistically analyzed document data. For example, the extraction unit 120 may recognize words (for example, region names such as country, province, and city) tagged with place entity names such as <LCP_PROVINCE>, <LCP_CITY>, and <LCP_COUNTY> from the linguistically analyzed event sentence to extract the event location information. To this end, a noun (region word information) meaning a region and a location may be previously stored in the storage unit 130.

Furthermore, the extraction unit 120 may extract the event location information using region information configured in a tree structure in order to infer the event location information (for example, country, province, city, and town) from insufficient information. For example, a phrase meaning a region in the event sentence of FIG. 3 is “Seohu-myeon, a township in Andong L1.” However, it is not obvious which province the city of Andong is located in. In this case, the extraction unit 120 may check that the city of Andong is located in North Gyeongsang Province (Gyeongbuk) using an address system of the region information stored in the storage unit 130 to extract the event location information.

When the event location information is extracted from the event sentence, the extraction unit 120 normalizes the extracted event location information. For example, as illustrated in FIG. 4, the extraction unit 120 may normalize the extracted event location information, Seohu-myeon/Andong-si/Gyeongbuk L2, into at least one of a region code and GPS coordinate L3. In this case, the region code is a combination of numbers assigned according to town/city/province, and the GPS coordinate is an absolute coordinate of (X, Y). Information about the region code and the GPS coordinate may be stored in the storage unit 130 and used to normalize the event location information. By normalizing the event location information, locations may be accurately displayed when the event information is visualized.

Furthermore, the extraction unit 120 may further extract user personal information about a host of the event. For example, the extraction unit 120 may extract the personal information, such as age and gender, about the host (user) of the document data by performing a profiling operation on the event sentence or document data.

As such, the extraction unit 120 may extract a plurality of event keywords from a plurality of document data items collected from a plurality of social web media. In addition, the extraction unit 120 may extract event-related information corresponding to the plurality of event keywords from the plurality of document data items collected in the plurality of social web media.

When the plurality of event keywords and the event-related information corresponding to the plurality of event keywords are extracted, the extraction unit 120 may set event keywords, which indicate the same event among the plurality of event keywords, as one event group. For example, event keywords, “foot-and-mouth disease,” “hoof-and-mouth disease,” and “Aphtae epizooticae,” indicating the same event, “food-and-mouth disease,” may be set (grouped) as one event group 51.

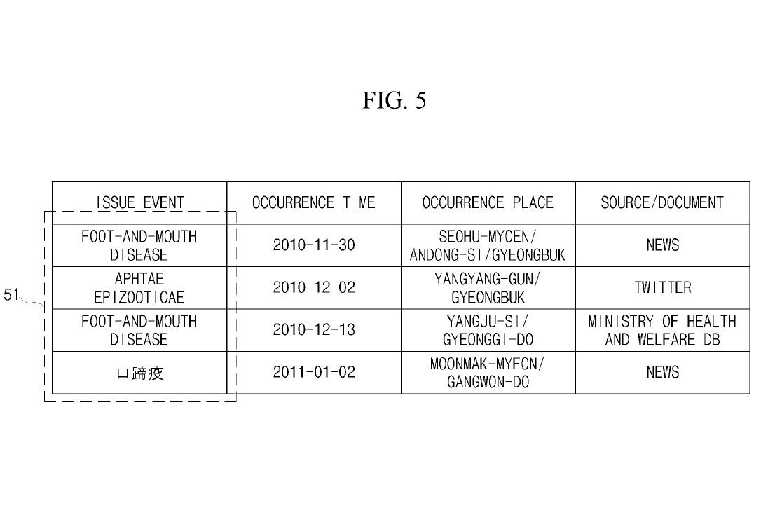

The extraction unit 120 analyzes a correlation between event keywords in the event group according to variation in time and location. For example, the extraction unit 120 may align the event of “foot-and-mouth disease” in order of event occurrence time, as illustrated in FIG. 5, using the event time information. In this case, the extraction unit 120 may analyze the correlation further using an open database (meteorological DB, disease DB, or disaster DB) of a social organization or public institution (the Meteorological administration, the Ministry of Health and Welfare, etc.). In addition, the event group extracted by the extraction unit 120, the plurality of event keywords included in the event group, and the event-related information corresponding to the plurality of event keywords may be accumulated and stored in the storage unit 130.

The storage unit 130 is configured to store data and may be a flash memory. The event keywords extracted by the extraction unit 120 and the event-related information for each event keyword are stored in the storage unit 130. Here, the event-related information includes event time-space information such as event time information and event location information. For example, the event time information may be stored in the storage unit 130 in a form of year-month-day (YYYY-MM-DD). In addition, the event location information may be stored in the storage unit 130 in a format of a predetermined and regularized combination of numbers. For example, the event location information may be stored as a region code of a combination of numbers or a GPS coordinate of (x, y). Furthermore, the event-related information may further include user personal information.

Moreover, the plurality of event keywords indicating the same event are set as one event group and stored in the storage unit 130. For example, event keywords, “foot-and-mouth disease,” “hoof-and-mouth disease,” and “Aphtae epizooticae,” indicating the same event, “food-and-mouth disease,” may be set (grouped) as one event group and stored in the storage unit 130. As such, if event keywords expressed in the Korean language, a foreign language, and a loanword indicate the same event, the event keywords may be set as one event group and previously stored in the storage unit 130. In addition, the event-related information corresponding to each of a plurality of event keywords included in one event group is stored in the storage unit 130. The output unit is configured to visualize and output an event keyword and event-related information corresponding to the event keyword. The output unit 140 may include a screen display device such as a Liquid Crystal Display (LCD). Preferably, the output unit 140 maps the event-related information corresponding to the event keyword onto a map image outputted on a screen to output a result of the mapping.

The input unit 150 may be a user interface for receiving an input from an administrator. As an example, the input unit 150 may include a typing input device, such as a keyboard, for receiving a word input from an administrator and a pointer input device, such as a mouse, for a selection input from an administrator. As another example, the input unit 150 may be a touch screen capable of receiving a touch input from the administrator, which may be implemented integrally with a screen display device of the output unit 140. The administrator may input an event keyword, an analysis time period, and region information of an event to be retrieved through the input unit 150.

When the event keyword is inputted from the administrator through the input unit 150, the output unit 140 visualizes and outputs the inputted event keyword and event-related information corresponding thereto. In this case, the output unit 140 may structuralize and convert the inputted information into a query language and then retrieve and obtain the event keyword and the event-related information corresponding thereto from the storage unit 130. Furthermore, the output unit 140 may visualize all event keywords and event-related information corresponding thereto included in an event group having the inputted event keyword.

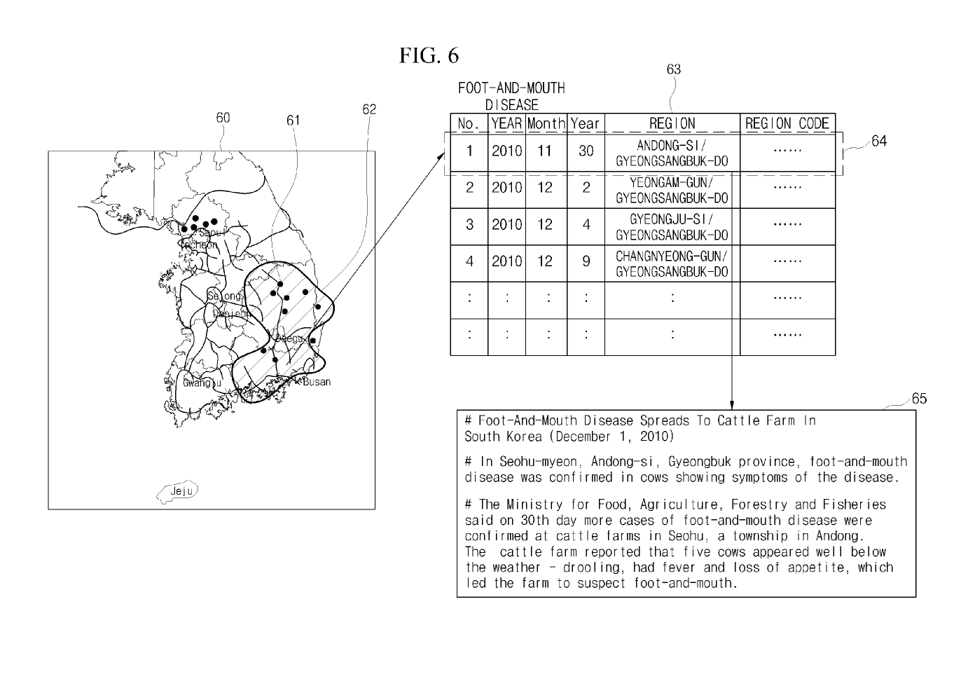

For example, when an event keyword of a ‘foot-and-mouth disease’ is inputted through the input unit 150, the output unit 140 may acquire event-related information corresponding to the event keyword stored in the storage unit 130, and map the event-related information onto the map image, as shown in a portion 60 of FIG. 6, using event location information of the event-related information, to output a result of the mapping (dots) 61. In this case, the output unit 140 may display accurate locations onto the map image using region code information or GPS coordinate information of the event location information. Moreover, the output unit 140 may display a region range including dots in the map image in a solid line 62.

If one dot is selected from among the dots displayed on the map image through the input unit 150 (primary selection), the output unit 140 may output only event-related information corresponding to the selected event location information (primary output). In addition, if a retrieval range is inputted in addition to the event keyword through the input unit 150, the output unit 140 may output only event-related information included in the retrieval range.

For example, if the retrieval range such as a specific date or period (for example, 2010 Nov. 29 to 2010 Dec. 9) is inputted in addition to the event keyword of ‘foot-and-mouth disease,’ the output unit 140 may check event time information of event-related information corresponding to the inputted event keyword, acquire only event-related information corresponding to the inputted date range from the storage unit 130, and then output the acquired event-related information. Furthermore, as shown in a portion 63 of FIG. 6, the output unit 140 may visualize and output the event-related information acquired from the storage unit 130 as a table.

If one piece of information 64 (event location information, event time information, or the like) is selected by the administrator through the input unit 150 from among the outputted event-related information (secondary selection), as shown in a portion 65 of FIG. 6, the output unit 140 may output document data (for example, a news article, etc.) from which the selected event-related information has been extracted (secondary output).

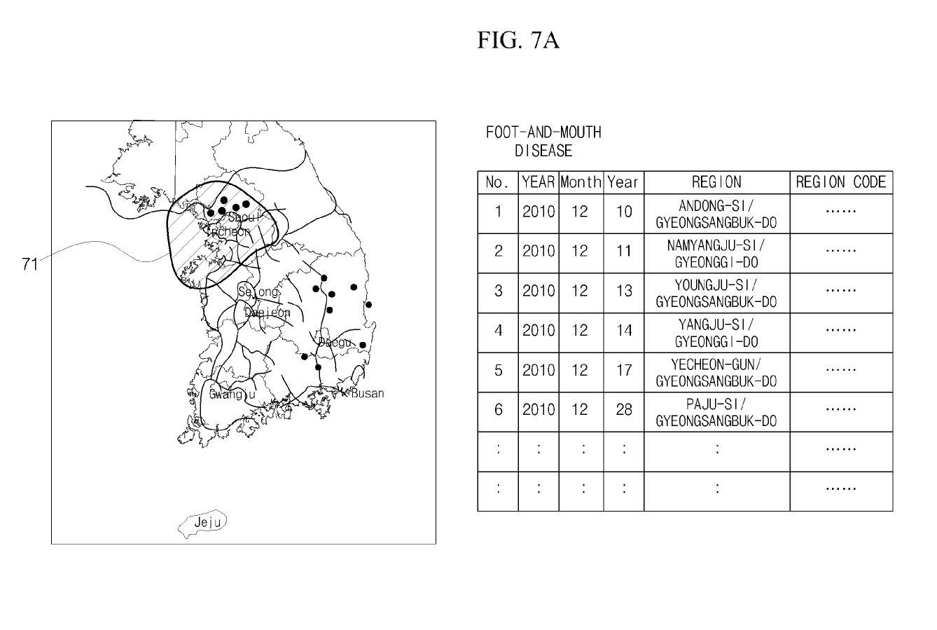

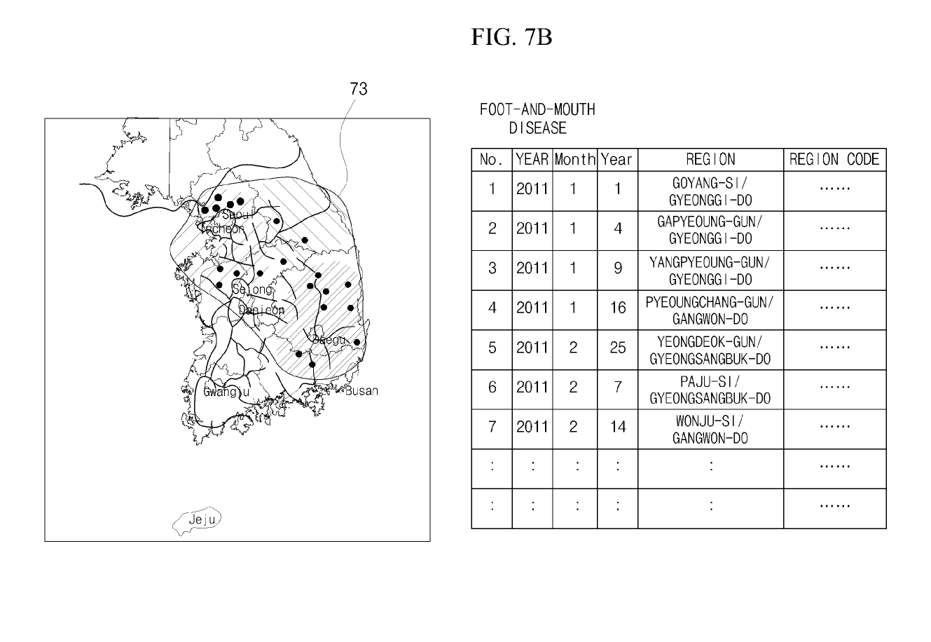

If a date range of 2010 Dec. 10 to 2010 Dec. 31 is inputted through the input unit 150 in addition to the event keyword of ‘foot-and-mouth disease,’ event-related information may be displayed on the screen as shown in FIG. 7A. If a date range of 2011 Jan. 1 to 2011 Feb. 15 is inputted through the input unit 150 in addition to the event keyword of ‘foot-and-mouth disease,’ event-related information may be displayed on the screen as shown in FIG. 7B. Thus, the administrator may check regions where the event of ‘foot-and-mouth disease’ has occurred on the basis of time and also check spatial distribution and spread of the foot-and-mouth disease over time.

As an example, as shown in a portion 60 of FIG. 6, it can be seen that the event of ‘foot-and-mouth disease’ had occurred around North Gyeongsang Province 62 at an initial stage (November, 2010), occurred in the capital area 71 on December, 2010, as shown in FIG. 7A, and spread all over the nation 73 on January, 2011, as shown in FIG. 7B. Accordingly the administrator can predict a spread direction of the event of ‘foot-and-mouth disease.’ If preventive measures against the disease were tightened in an intermediate range when the foot-and-mouth disease was spread to the capital region on December, 2010, there might be the higher possibility that the nationwide spread on January, 2011 was prevented.

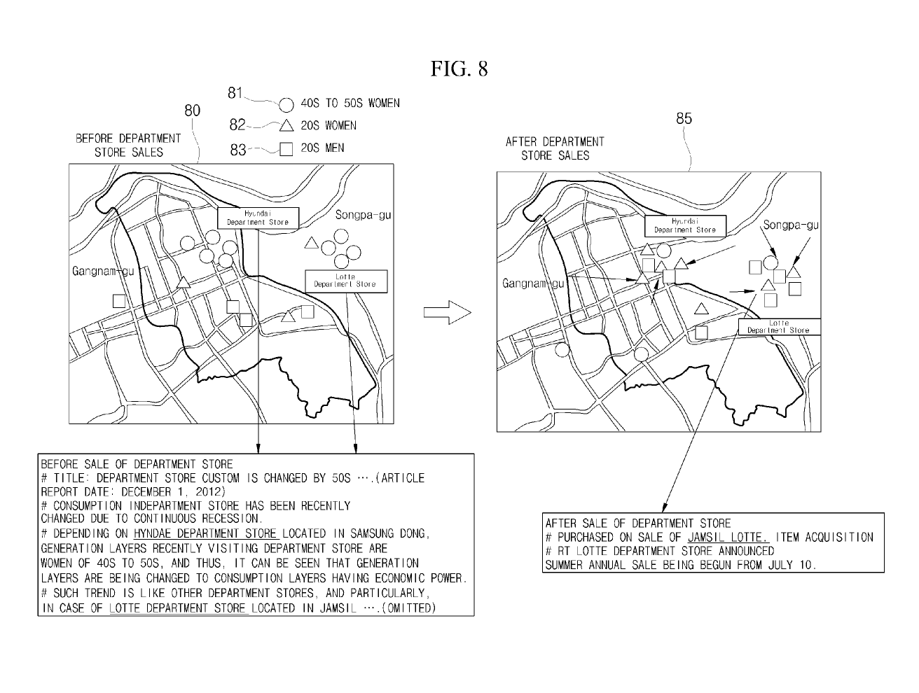

Another example, the output unit 140 may display a user group in a different shape as shown in FIG. 8, using user personal information of the event-related information corresponding to the event keyword. For example, the administrator may check distribution of a user group before department store sales as shown in a portion 80 of FIG. 8, and after department store sales as shown in a portion 85 of FIG. 8, according to an event of ‘department store sales.’ That is, the administrator can realize that 40's and 50's women 81 mainly mention the event near the department store before the event of ‘department store sales’ 80 and 20s and 30s women and men 82 and 83 mainly mention the event after the event of ‘department store sales’ 85. Thus this may be utilized to select a marketing target.

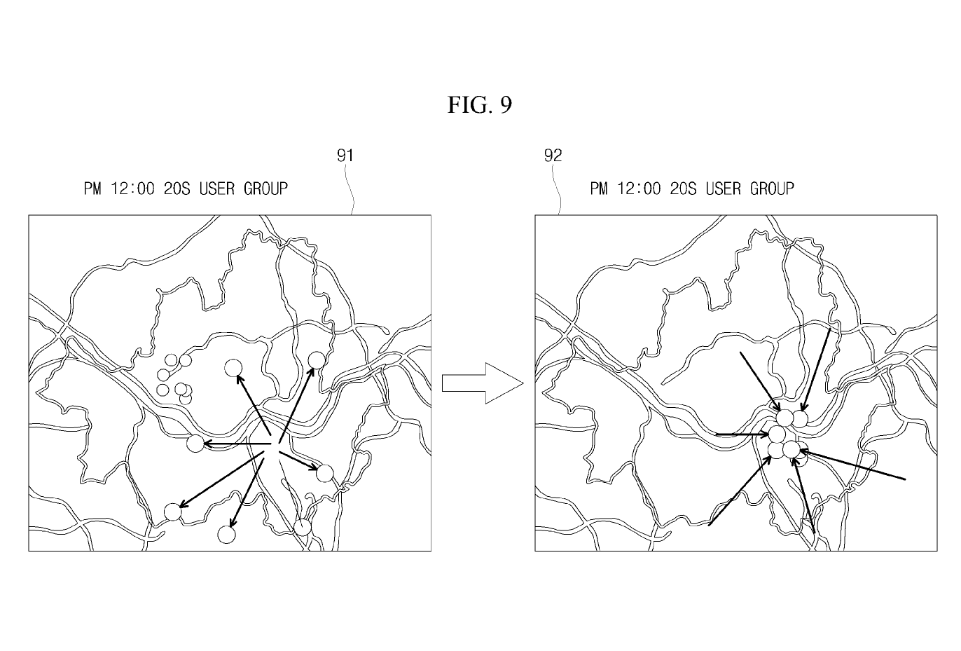

Still another example, the output unit 140 may display only a specific user group as shown in FIG. 9, using user personal information of the event-related information corresponding to the event keyword. For example, the administrator can realize a distribution region 91 of a group of 20s users at a lunch time and a distribution region 92 of the group at a dinner time as shown in FIG. 9 according to an event of ‘food’ or ‘meal.’ This may be utilized to select a marketing location based on time for each user group.

As such, according to an embodiment of the present invention, unlike a method of extracting time information or space information using metadata formatted and attached to an existing social web media, it is possible to analyze time-space continuity and correlation of an event faster than receipt of disaster damages and collection of relevant data by the authorities, by recognizing and normalizing the time information or space information expressed with various words through analysis of text content in a social web media that is uploaded in real time.

In addition, according to another embodiment of the present invention, it is possible to facilitate prediction of spreading direction of a specific event or incident using a visualized result and thus allow an effective follow-up action or response to the event, by grouping the same issue (event or incident) and visualizing a process of how the specific incident is moved, changed, and spread according to time or space.

Moreover, according to still another embodiment of the present invention, it is possible to effectively select a marketing target (user group) before and after a specific issue occurs or according to occurrence tendency by finding out change of user groups according to a specific event and time/place.

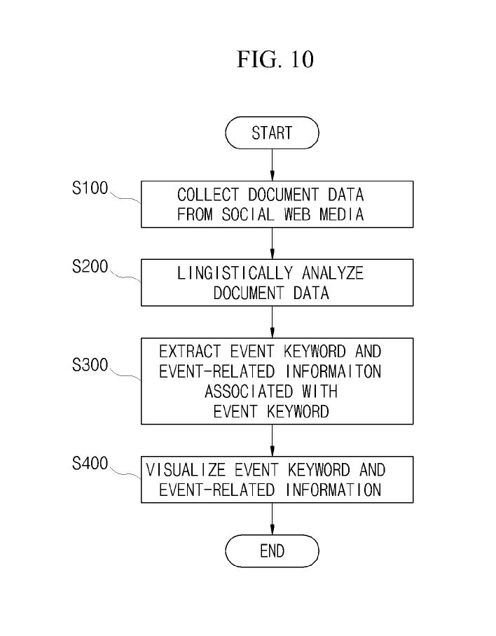

FIG. 10 is a flowchart illustrating a method of operating an apparatus for analyzing an event correlation over time and space in a social web media according to an embodiment of the present invention.

First, the apparatus for analyzing an event correlation over time and space collects a text type of document data from the social web media in operation S100.

Specifically, the apparatus 100 may collect the document data from a variety of information sources (for example, a social web media such as a Social Networking Service (SNS) having a news, a blog, Twitter, and Facebook). In addition, the apparatus 100 may collect the document data from a database of a public institution if the document data is accessible to the public.

The apparatus 100 analyzes a language contained in the document data collected by the collection unit 110 in operation S200.

Specifically, the apparatus 100 performs at least one of morphology analysis and Named Entity Recognition (NER) to linguistically analyze the document data.

The apparatus 100 extracts an event keyword and also event-related information associated with the event keyword from the linguistically analyzed document data in operation S300.

Specifically, the apparatus 100 selects an event sentence having a high possibility of including the event keyword from among the document data linguistically analyzed in operation S200. Here, the event sentence is a core element of the event information, which includes details of the event and has a high possibility of including information about an event occurrence time and an event occurrence place. Thus event time-space Information including event time information and event location information may be extracted from the event sentence.

When the event sentence is selected, the apparatus 100 extracts an event keyword from the selected event sentence. Here, the event keyword may be a noun in the event sentence, such that the apparatus 100 may extract the event keyword from the event sentence using a result of the morphology analysis or named entity recognition.

When the event keyword is extracted, the apparatus 100 extracts and normalizes the event time information from the event sentence. For example, the apparatus 100 may extract the event time information by recognizing a noun meaning a date from the linguistically analyzed document data. Additionally, the apparatus 100 may extract the event time information in consideration of a creation or modification time when the document data is attached (posted) to a social web media in order to infer the event time information (for example, year, month, day, and time) from insufficient information.

In addition, the apparatus 100 normalizes the extracted event time information. Here, the normalization form may be predetermined, and one of various forms such as YYYY-MM-DD, YY-MM-DD, and MM-DD-YY may be predetermined. As such, by normalizing the event time information, the event information may be effectively sorted in order of time.

When the event keyword is extracted, the apparatus 100 extracts and normalizes the event location information from the event sentence. For example, the apparatus 100 may extract the event time information by recognizing a proper noun meaning a region from the linguistically analyzed document data. Furthermore, the apparatus 100 may extract the event location information using an address system of region information configured in a tree structure in order to infer the event location information (for example, country, province, and city) from insufficient information.

In addition, the apparatus 100 normalizes the extracted event location information. Here, the normalization form may be predetermined to be at least one of a combination of numbers assigned according to town/city/province and the GPS coordinate of (X, Y). As such, by normalizing the event location information, locations may be accurately displayed when the event information is visualized.

Furthermore, the apparatus 100 may further extract user personal information about a host of the event. For example, the apparatus 100 may extract the personal information, such as age and gender, about the host (user) of the document data by performing a profiling operation on the event sentence or document data.

Furthermore, the apparatus 100 may set event keywords, which indicate the same event among the plurality of event keywords, as one event group. Specifically, the apparatus 100 may extract a plurality of event keywords from a plurality of pieces of document data collected from a plurality of social web media. For example, event keywords, “foot-and-mouth disease,” “hoof-and-mouth disease,” and “Aphtae epizooticae,” indicating the same event, “food-and-mouth disease,” may be set (grouped) as one event group.

Furthermore, the apparatus 100 may extract the event-related information including at least one of the event time information, the event location information, and the user personal information, corresponding to the extracted plurality of event keywords.

As such, the extracted event group, the plurality of event keywords included in the event group, and the event-related information corresponding to the plurality of event keywords may be accumulated and stored in a DataBase (DB).

When the event keyword and the event-related information are extracted, the apparatus 100 visualizes the extracted event keyword and the event-related information in operation S400.

When the event keyword is inputted from the administrator over an external interface, the apparatus 100 may visualize and output the inputted event keyword and event-related information corresponding thereto. In this case, the apparatus 100 may structuralize and convert the inputted information into a query language and then retrieve and obtain the event keyword and the event-related information corresponding thereto from the database.

In addition, the apparatus 100 may visualize all event keywords and event-related information corresponding thereto included in an event group having the inputted event keyword.

For example, when the event keyword is inputted over the external interface, the apparatus 100 may acquire event-related information corresponding to the event keyword stored in the database, and map the event-related information onto the map image using event location information of the event-related information to output a result of the mapping. In this case, the apparatus 100 may display accurate locations onto the map image using region code information or GPS coordinate information of the event location information.

If one dot is selected from among the dots displayed on the map image through the external interface (primary selection), the apparatus 100 may output only event-related information corresponding to the selected event location information (primary output). In addition, if a retrieval range is inputted in addition to the event keyword through the external interface, the apparatus 100 may output only event-related information included in the retrieval range. Furthermore, the apparatus 100 may visualize and output the event-related information acquired from the database as a table.

If one piece of information (event location information, event time information, or the like) is selected by the administrator through the external interface from among the outputted event-related information (secondary selection), the apparatus 100 may output document data (for example, a news article, etc.) from which the selected event-related information has been extracted (secondary output).

As such, according to an embodiment of the present invention, unlike a method of extracting time information or space information using metadata formatted and attached to an existing social web media, it is possible to analyze time-space continuity and correlation of an event faster than receipt of disaster damages and collection of relevant data by the authorities, by recognizing and normalizing the time information or space information expressed with various words through analysis of text content in a social web media that is uploaded in real time.

In addition, according to another embodiment of the present invention, it is possible to facilitate prediction of spreading direction of a specific event or incident using a visualized result and thus allow an effective follow-up action or response to the event, by grouping the same issue (event or incident) and visualizing a process of how the specific incident is moved, changed, and spread according to time and region.

Moreover, according to still another embodiment of the present invention, it is possible to effectively select a marketing target (user group) before and after a specific issue occurs or according to occurrence tendency by finding out change of user groups according to a specific event and time or space.

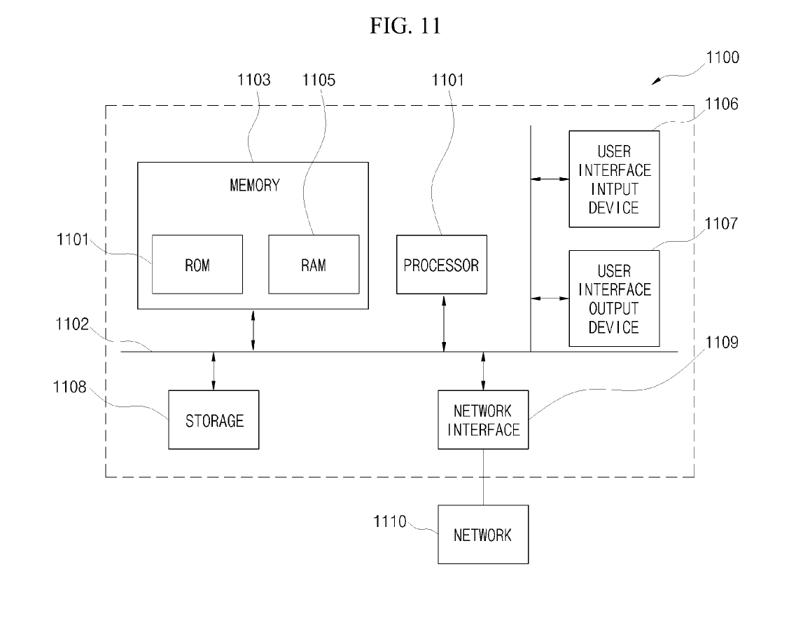

An embodiment of the present invention may be implemented in a computer system, e.g., as a computer readable medium. As shown in in FIG. 11, a computer system 1100 may include one or more of a processor 1101, a memory 1103, a user input device 1106, a user output device 1107, and a storage 1108, each of which communicates through a bus 1102. The computer system 1100-1 may also include a network interface 1109 that is coupled to a network 1110. The processor 1101 may be a Central Processing Unit (CPU) or a semiconductor device that executes processing instructions stored in the memory 1103 and/or the storage 1108. The memory 1103 and the storage 1108 may include various forms of volatile or non-volatile storage media. For example, the memory may include a Read-Only Memory (ROM) 1104 and a Random Access Memory (RAM) 1105.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

This invention has been particularly shown and described with reference to preferred embodiments thereof. It will be understood by those skilled in the art that various changes in form and details may be made therein without departing from the spirit and scope of the invention as defined by the appended claims. Accordingly, the referred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for analyzing an event time-space correlation in a social web media, the apparatus comprising:
a collection unit configured to collect a text type of document data from the social web media;
an extraction unit configured to analyze a language contained in the document data to extract an event keyword indicating an event and event-related information associated with the event keyword based on a result of the analysis;
a storage unit configured to store the extracted event keyword and event-related information; and
an output unit configured to receive the event keyword and event-related information and convert the received event keyword and event-related information into visual information and output the visual information.

2. The apparatus of claim 1, wherein the event-related information comprises at least one of user personal information and event time-space information including event time information and event location information about the event.

3. The apparatus of claim 1, wherein the extraction unit performs at least one of morphology analysis and Named Entity Recognition (NER) to analyze the language contained in the document data.

4. The apparatus of claim 2, wherein the extraction unit selects an event sentence including the event keyword from among the analyzed document data and extracts the event-related information using vocabulary data included in the event sentence.

5. The apparatus of claim 4, wherein the extraction unit extracts the event time information in additional consideration of at least one of a document creation time and a document modification time when the document data is attached to the social web media.

6. The apparatus of claim 4, wherein the extraction unit extracts the event location information using at least one of a creation location coordinate data where the document data is attached to the social web media and vocabulary data indicating a location in the document data.

7. The apparatus of claim 2, wherein the extraction unit normalizes the event location information of the event time-space information into a predetermined combination of numbers.

8. The apparatus of claim 2, wherein the extraction unit extracts a plurality of event keywords indicating the same event as the event keyword from document data collected from a plurality of social web media, sets the plurality of event keywords as one event group, and extracts event-related information corresponding to the plurality of event keywords contained in the event group from the document data.

9. The apparatus of claim 8, wherein the extraction unit sorts relations between the plurality of event keywords contained in the event group with respect to one piece of information among the related-art information to check a correlation therebetween.

10. The apparatus of claim 2, wherein the output unit maps the event-related information onto a map image to output a result of the mapping.

11. The apparatus of claim 2, further comprising an input unit configured to receive a retrieval range of the event keyword and the event-related information,
wherein the output unit acquires the event-related information included in the retrieval range from the storage unit corresponding to the received event keyword to output the acquired event-related information.

12. The apparatus of claim 2, wherein when at least one piece of information is primarily selected from among the outputted event-related information, the output unit acquires the event keyword corresponding to the primarily selected event-related information and the event-related information from the storage unit to primarily output the event related information, and
when at least one piece of information is secondarily selected from among the primarily outputted event-related information, the output unit secondarily outputs the document data from which the secondarily selected event-related information has been extracted.

13. A method of operating an apparatus for analyzing an event time-space correlation in a social web media, the method comprising:
collecting a text type of document data from the social web media;
analyzing a language contained in the collected document data;
extracting an event keyword indicating an event and event-related information associated with the event keyword based on a result of the linguistic analysis; and
mapping the event keyword and the event-related information onto a map image to display a result of the mapping on a screen.

14. The method of claim 13, wherein the extracting comprises extracting as the event-related information event time-space information including event time information and event location information about the event and user personal information associated with the event.

15. The method of claim 14, wherein the analyzing comprises performing at least one of morphology analysis and named entity recognition to analyze the language contained in the document data.

16. The method of claim 14, wherein the extracting comprises:
selecting an event sentence including the event keyword from among the document data based on a result of the linguistic analysis; and
extracting the event-related information using vocabulary data contained in the selected event sentence.

17. The method of claim 14, wherein the extracting comprises extracting the event time information in consideration of at least one of a document creation time and a document modification time when the document data is attached to the social web media.

18. The method of claim 14, wherein the extracting comprises normalizing and extracting the event location information using at least one of previously stored GPS coordinate information and region code information.

19. The method of claim 14, wherein the extracting comprises:
extracting a plurality of event keywords indicating the same event as the event keyword from document data collected from a plurality of social web media to set the extracted plurality of event keywords as one event group; and
extracting event-related information corresponding to the plurality of event keywords contained in the event group from the document data.

20. The method of claim 14, wherein the outputting comprises:
when at least one piece of information is primarily selected from among the outputted event-related information, primarily outputting the event keyword corresponding to the primarily selected event-related information and the event-related information; and
when at least one piece of information is secondarily selected from among the primarily outputted event-related information, secondarily outputting the document data from which the secondarily selected event-related information has been extracted.
